(19) United States
(12) Patent Application Publication
(10) Pub. No.: US 2022/0288921 A1
(43) Pub. Date: Sep. 15, 2022

(54) CROSS-NOZZLE ABNORMALITY DETECTION IN DROP DETECTOR SIGNALS

(71) Applicant: Hewlett-Packard Development Company, L.P., Spring, TX (US)

(72) Inventors: Andreu VINETS ALONSO, Sant Cugat del Valles (ES); Javier DEOCON MIR, Sant Cugat del Valles (ES); Antonio GRACIA VERDUGO, Sant Cugat del Valles (ES)

(73) Assignee: Hewlett-Packard Development Company, L.P., Spring, TX (US)

(21) Appl. No.: 17/634,506

(22) PCT Filed: Sep. 23, 2019
(86) PCT No.: PCT/US2019/052423

§ 371 Date: Feb. 10, 2022

(51) Int. Cl. B41J 2/045

(52) U.S. Cl. CPC B41J 2/0451; B41J 2/0458

(57) ABSTRACT

In an example, a print apparatus includes a printhead carriage to receive a printhead comprising a print agent ejection nozzle, a drop detector to acquire a signal indicative of variations in a parameter detected by the drop detector over a period of drop detection; a memory to store nozzle location information of the nozzles; and processing circuitry comprising a correlation module to correlate the drop detector signal with the nozzle location information wherein the processing circuitry comprises an abnormality detection module to determine, based on an output of the correlation module, a cross-nozzle abnormality that affects a subset of nozzles.

### BACKGROUND

Print apparatus utilise various techniques to disperse print agents such as coloring agent, for example comprising a dye or colorant, coating agents, thermal absorbing agents and the like. Such apparatus may comprise a printhead. An example printhead includes a set of nozzles and a mechanism for ejecting a selected agent as a fluid, for example a liquid, through a nozzle. In such examples, a drop detector may be used to detect whether drops are being ejected from individual nozzles of a printhead. For example, a drop detector may be used to determine whether any of the nozzles are clogged and would benefit from servicing or whether individual nozzles have failed permanently.

In some cases, the abnormalities may be so severe that affect a plurality of nozzles, e.g., an object obstructing some of them. In those cases, standard servicing routines may not be effective enough, so their identification is particularly beneficial.

### BRIEF DESCRIPTION OF DRAWINGS

Non-limiting examples will now be described with reference to the accompanying drawings, in which:

FIG. 1 is a simplified schematic of an example print apparatus;

FIG. 2 is a simplified schematic of an example drop detector;

FIG. 3 is an example of a drop detector signal;

FIG. 4 is an example of an architecture of a print engine comprising seven printhead positions, each printhead having two colors;

FIG. 5A is a graph showing signals obtained by a drop detector for a print engine architecture such as the one of FIG. 4, the graph showing abnormalities;

FIG. 5B is a graph obtained for the same print engine of FIG. 5A without the abnormalities;

FIG. 6 is a flowchart of an example cross-nozzle abnormality detection method.

### DETAILED DESCRIPTION

The present disclosure refers to a print apparatus that allows for determining abnormalities that affect a plurality of nozzles within a printing a system so that special servicing routines and/or visual inspection may be recommended to a user. In particular, it is herein disclosed a printing system comprising:
a printhead carriage to receive a printhead comprising print agent ejection nozzles;
a drop detector to acquire a signal indicative of variations in a parameter detected by the drop detector over a period of drop detection;
a memory to store nozzle location information of the nozzles; and
processing circuitry comprising a correlation module to correlate the drop detector signal with the nozzle location information
   wherein the processing circuitry comprises an abnormality detection module to determine, based on an output of the correlation module, a cross-nozzle abnormality that affects a subset of nozzles.

In an example, the abnormality detection module determines a cross-nozzle abnormality for the subset of nozzles having abnormal drop detection that are separated by less than a threshold signal. An abnormal drop detection may be, e.g., a drop detection with the parameter outside a parameter threshold value. Examples of such parameters may be one of a drop velocity, drop volume, drop detector signal intensity.

In a further example, the drop detector comprises a radiation detector to detect radiation intensity.

Further, the print apparatus may comprise a plurality of printheads and, in such a case, the abnormality detection module may group a first cross-nozzle abnormality associated to a first printhead with a second cross-nozzle abnormality associated to a second printhead as a cross-printhead abnormality.

The abnormality detection module may, in an example, determine a cross-printhead abnormality when the first cross-nozzle abnormality is determined at a similar distance with the second cross-nozzle abnormality along a dimension of the print carriage, i.e., when both abnormalities occur at a similar position along the carriage.

An output from the abnormality detection module may be used by the system to provide the user an indication of blocking artefact is issued so that appropriate servicing measures are taken.

Moreover, it is herein disclosed a method comprising a processor to:
acquire a signal from a detector to detect a passage of print agent ejected from a printhead nozzle;
determine, using a processor an operational parameter of the printhead nozzle;
determine a set of locations of a subset of nozzles having abnormal operational parameters; and
determine a cross-nozzle abnormality for the subset of nozzles whose locations are within a similar distance from a reference within printhead carriage.
   wherein the reference in the above-described method may be, e.g., an edge of the printhead carriage.

In an example, the detector comprises a radiation detector to detect radiation intensity.

Also, the parameter may be, for example, one of a drop velocity, drop volume, a signal intensity.

Likewise, the present disclosure refers to a tangible machine-readable medium comprising instructions which, when executed by a processor, cause the processor to:
acquire a signal from a detector to detect a passage of print agent ejected from a printhead nozzle;
determine, using a processor an operational parameter of the printhead nozzle;
determine a set of locations of a subset of nozzles having abnormal operational parameters;
determine a cross-nozzle abnormality for the subset of nozzles whose locations are within a similar distance from a reference within printhead carriage.

In an example, as mentioned above, the reference is an edge of the printhead carriage. Also, the detector may comprise a radiation detector to detect radiation intensity.

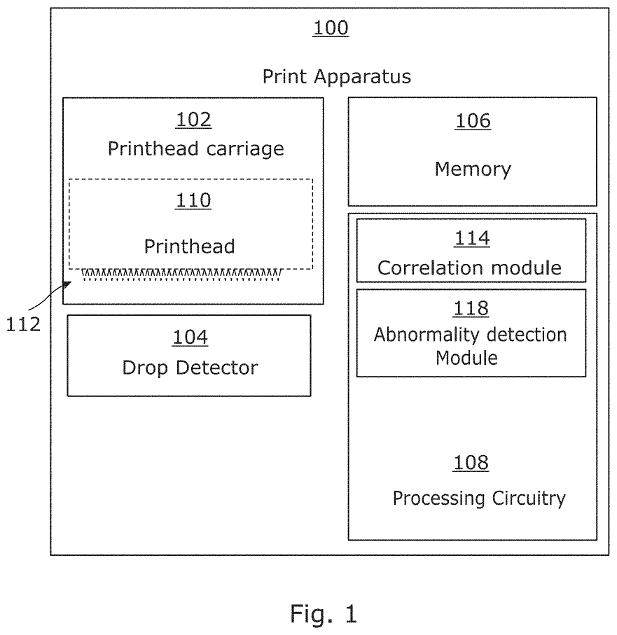

Referring now to the figures, FIG. 1 shows an example of a print apparatus 100, which may, for example, be for two-dimensional printing (for example for applying drops of a print agent such as ink on to a substrate such as paper, card, plastic, metal or the like) or three-dimensional printing (for example, applying drops of print agents which cause selective fusing or coloring of a build material, for example a powdered build material such as a plastic powder). The print apparatus 100 comprises a printhead carriage 102, a drop detector 104, a memory 106 and processing circuitry 108. In some examples, the print apparatus 100 may be configured, for example using the processing circuitry 108 thereof, to determine an operational parameter or performance parameter of at least one nozzle of a printhead mounted therein.

The printhead carriage 102 is to receive a printhead 110 (which may be a removable and/or replaceable component and is shown in dotted outline) comprising at least one print agent ejection nozzle 112. In some examples, the printhead carriage 102 may be mounted such that it can be repositioned in the print apparatus 100. In some examples the printhead 110 may be an inkjet printhead, such as a thermal inkjet printhead.

A drop detector 104 may be included in the print apparatus 100 to acquire a signal indicative of variations in a parameter. Such parameter may be detected by the drop detector 104 over a period of drop detection. In some examples, this signal may characterise the passage of print agent ejected from a nozzle through a sampling volume. However, as is further discussed below it may be that a nozzle has failed and there may be no print agent to detect in the period of drop detection. Nevertheless, the drop detector 104 may acquire a signal. Examples of operational parameters that may be detected by the drop detector 104 include and are not limited to nozzle health parameters e.g., a drop volume, a drop velocity, and/or a drop size.

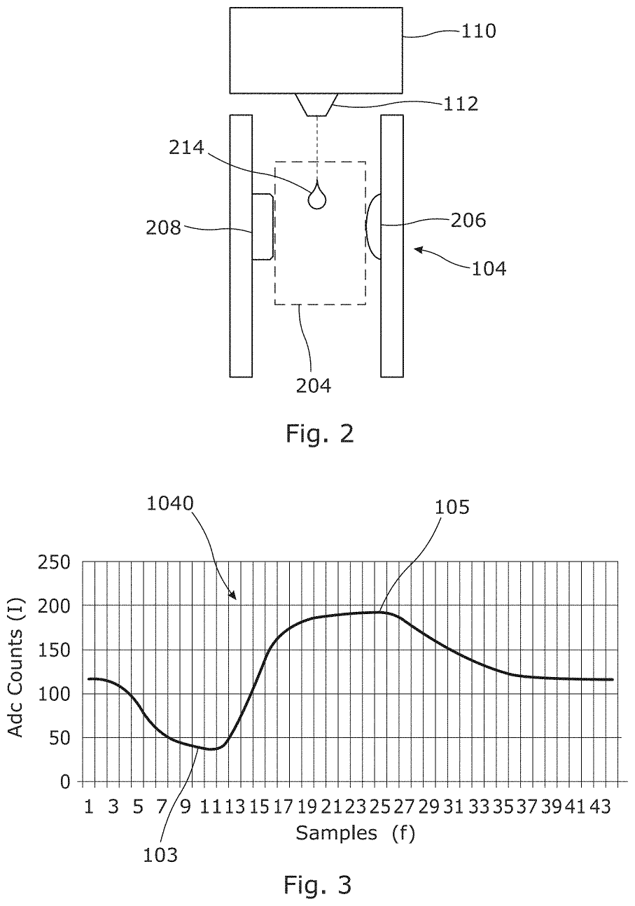

For example, a drop detector 104 may comprise at least one radiation detector and at least one radiation emitter (although ambient radiation could be detected in some examples). In such examples, a feature which varies during a drop detection period may be radiation intensity level, although in other examples, it could be, for example, a wavelength, a frequency or any other parameter which may be collected by a drop detector and associated to an operational parameter of the nozzle, e.g., to a nozzle health parameter such as those previously described. An example of a drop detector 104 is shown in FIG. 2 and discussed in greater detail below, in which a plurality of drop detection units each comprising a light source (e.g. at least one LED (Light Emitting Diode) and light detector (e.g. at least one photodiode) straddle a sampling volume and may detect a drop passing though the sampling volume. In other examples, other types of drop detector may be used, for example those based on gamma or beta ray radiation detection or drop detectors with a mirror which returns the radiation emitted by an emitter to a collocated receiver, or which rely on light scattered back from the drop of print agent the like. In some examples, the drop detector 104 may be repositioned relative to the printhead carriage 102, such that it can detect the emission of drops from different nozzles 112 or sets of nozzles depending on its position.

In some examples, a print apparatus 100 may comprise a plurality of printhead carriages 102, each of which is to receive a printhead 110. In such examples, a drop detector 104 may be provided for each printhead carriage 102. In some examples, the drop detector 104 may be used to monitor each of a group of nozzles of a printhead 110 in turn. For example, a printhead 110 may comprise two thousand, one hundred and twelve nozzles, and the drop detector 104 may be positioned to detect the output of ninety-six nozzles at a time.

The memory 106 may be any form of computer readable storage medium, for example disc storage, CD-ROM, optical storage, magnetic storage, flash storage, memory caches, buffers, etc. The memory 106 may store readings from the drop detector 104, e.g., the readings for a complete measurement of a plurality of nozzles within a print apparatus 100, thereby allowing their further analysis by the processing circuitry 108. Also, the memory 106 may be to store the locations of the nozzles within a print apparatus to be able to identify them. Also, the processing circuitry 108 may comprise any form of processing circuitry, for example, any or any combination of a CPU, processing unit, ASIC, logic unit, a microprocessor, programmable gate array or the like. The convolution module 114 may for example be implemented by a processor executing machine readable instructions stored in a memory, or a processor operating in accordance with instructions embedded in logic circuitry, or the like.

The processing circuitry 108 comprises a correlation module 114 to correlate each drop detector signal with location information of each of the nozzles for which a drop detection has been done. The output of the correlation module 114 may be used to determine an indication of possible abnormalities that affect several nozzles. i.e., a cross-nozzle abnormality that may not be corrected with standard servicing or servicing intended for single-nozzle abnormalities.

Also, the processing circuitry 108 comprises an abnormality detection module 118. The abnormality detection module 118 is to determine, based on an output of the correlation module, a cross-nozzle abnormality that affects a subset of nozzles 112. Such determination of cross-nozzle abnormality helps identify issues, e.g., physical blockages that may affect several nozzles 112 and that may not be effectively solved by using standard nozzle-specific servicing strategies. In an example, the cross-nozzle abnormality may be, e.g., an artefact external to the print apparatus that blocks some of the nozzles thereby severely affecting print quality.

The abnormality detection module 118 may receive information from the drop detector 104 or retrieve it from the memory 106 as to the measurements for a plurality of nozzles 112, then, the module may identify if the drop detector signals may be affected by a common abnormality, e.g., that nozzles 112 corresponding to a particular area are showing defects in the drop detection analysis. Then, the abnormality detection module 108 may take appropriate servicing to solve cross-nozzle issues or may issue an alert to the user, e.g., for visual inspection.

In an example, the abnormality detection module 118 is to receive readings from the drop detector 104 for the nozzles and identify if nozzles within a specific section are suffering from similar defects in the drop detection analysis. For example, the abnormality detection module 118 may determine if neighbouring nozzles are showing similar defects in the drop detection signal, e.g., the module 118 may have configured a threshold distance and analyse the nozzles within the threshold distance to analyse if similar effects are seen on an area defined to the threshold distance. In a further embodiment, the module 118 may determine if nozzles within a determined distance from the edge of the carriage are suffering similar defects, e.g., several nozzles close to an edge of the carriage are showing similar abnormalities.

In particular, the abnormality detection module 118 correlates information associated to the position of the nozzles with information obtained from the drop detector 104 and determines that an abnormality may be creating cross-nozzle defects and a special servicing operation may be beneficial.

While in FIG. 1 the processing circuitry 108 and memory 106 are shown as being local to the printhead carriage 102 and the drop detector 104, this may not be the case and, in an example, either may be remote thereto. For example, the processing circuitry 108 may receive data from the drop detector 104 and/or memory 106 remotely, for example via the Internet.

FIG. 2 shows an example of a drop detector 104 in conjunction with printhead 110. In this example, a plurality of drop detection units 104 (just one of which is visible in the view shown) straddle a sampling volume 204. Each drop detection unit 202 comprises a light source 206 and a radiation detector, in this example a light detector 208. The drop detection units 104 are arranged to detect a drop 214 passing though the sampling volume 204 between the light source 206 and the light detector 208. For example, if the light source 206 of a drop detection unit 104 is emitting light, the arrangement may be such that this light is incident on the light detector 208 of the drop detection unit 104. A drop 214 passing therebetween creates a shadow and the intensity of light detected by the light detector 208 decreases, allowing the presence of a drop to be detected. In this example, the light sources 206 comprise LEDs (Light Emitting Diodes), and the light detectors 208 may comprise photodiodes.

As is shown in FIG. 2, a printhead 110 may comprise a plurality of nozzles 112 (just one of which is visible in the view shown), which may each eject a drop 214. An example drop 214 may enter the sampling volume 204 at time T1. The drop 214 in this example has a ‘tail’ due to the way it exits a nozzle 112 (i.e. it may not be a spherical drop), which exits the sampling volume 204 at a later time T2. As the tail comprises less fluid, it may allow more light through and thus the light detected at a light detector 208 will decrease before gradually increasing.

Drop detectors 104 may be used to identify when a nozzle 112 of a printhead 110 has ceased to emit print agents. There may be various reasons why a nozzle 112 may not emit print agent. For example, in a thermal inkjet print apparatus, high temperatures can be reached within a firing chamber of the printhead and electrical components (for example, a resistive heating element which causes the heating) may break, rendering it inoperative. In addition, due to the high temperatures levels or simply over time, print agent may partially evaporate, leaving a solid residue (for example, where the print agent is ink, this residue may be ink pigments). ‘Kogation’ of a printhead nozzle may also occur, in which, over time, components of the ink may accumulate on a resistive heating element, which reduces its thermal emissions, making it less energy-efficient, and reducing the volume and velocity of drops fired. A nozzle may therefore become partially or completely inoperative, affecting the print apparatus image quality. The type of defect may be exclusive to a nozzle and not have cross-nozzle effect, therefore, servicing routines may be less severe and easier to implement.

On the other hand, cross-nozzle abnormalities may require a different type of servicing, in some cases, a more severe servicing or even a replacement. Nonetheless, in some cases, it may be a physical blockage by an artefact, e.g., a piece of paper that may be easily removed by an operator but very difficult to remove by standard servicing routines. Therefore, there is benefit in differentiating between single-nozzle abnormalities and cross-nozzle abnormalities.

As mentioned above, the information provided by a drop detector may allow an indication of the operational status of the nozzles of each printhead, which may provide feedback for use in error hiding mechanisms (for example, using an operative nozzle in place of an inoperative nozzle during printing), print apparatus maintenance and/or servicing, and the like. Incorrect feedback information can result in inappropriate error correction (and therefore image quality issues) or inappropriate servicing, or the like.

It is possible to use a peak-to-peak value of a drop detector signal to detect a drop. In a drop detector which is based on optical intensity, this peak-to-peak measurement may therefore indicate the maximum light intensity and the minimum light intensity over a sampling period. If this value is above a given threshold, the nozzle is considered to be in a good operational state. Conversely, if the peak-to-peak value is below the given threshold the nozzle may be considered to be in a poor operational state, for example being blocked or partially blocked.

While this approach is effective in many cases, it is reliant on the setting of the threshold. For example, a threshold may be set to be relatively low, so as to minimise the number of false designations of a nozzle as being faulty, but this means that a partially blocked or otherwise poorly functioning nozzle, which may emit a smaller volume of print agent, may be categorised as being in a good state until almost complete or complete failure. Moreover, such a threshold-based approach may be vulnerable to electrical noise, either conducted or radiated, since such electrical noise may create peak-to-peak values that are above the threshold value. In some cases, the effect of electrical noise may be sufficient to generate a signal which has a significant peak-to-peak value, and this could lead to a nozzle being categorised as being fully operation regardless of its true state.

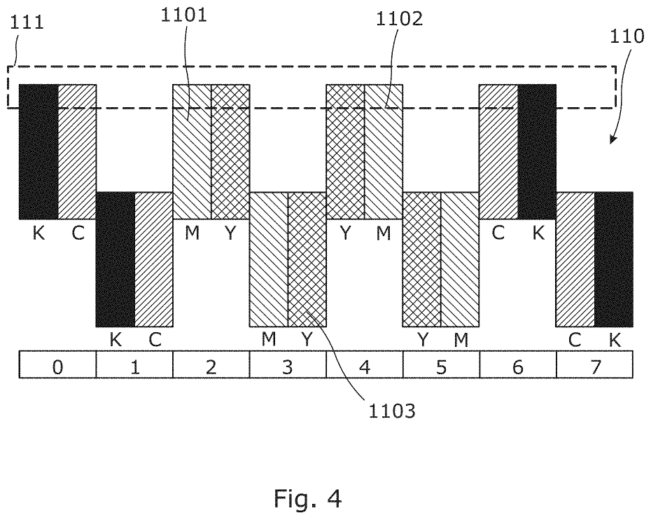

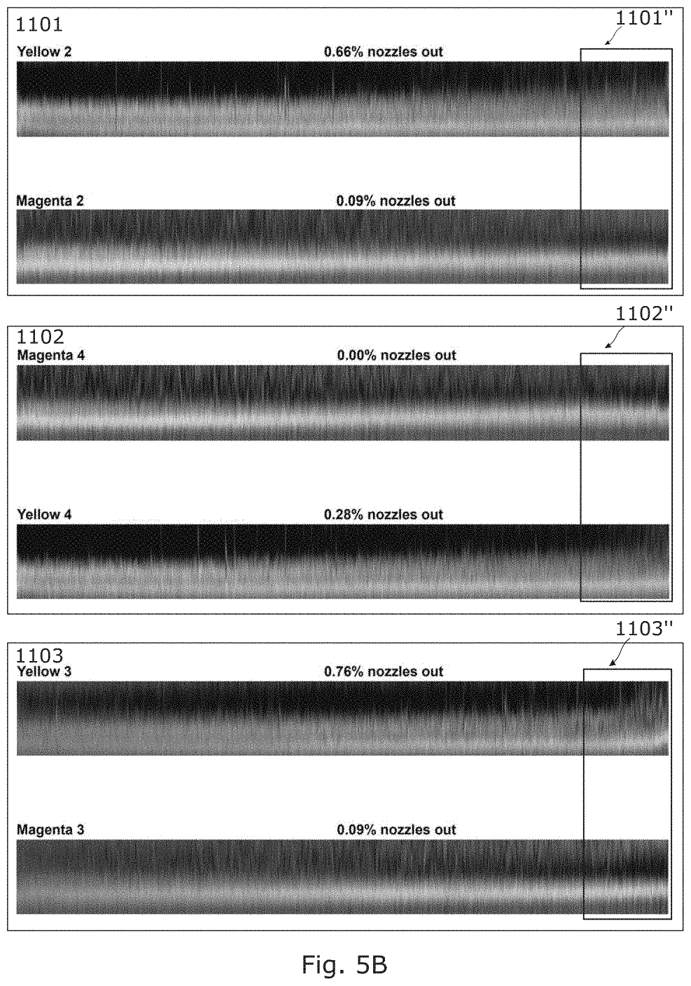

FIG. 3 shows an example of a drop detector signal 1040 which may be collected from a ‘heathy’ nozzle. As the liquid moves through the sampling volume 204, a count indicative of a radiation intensity value is recorded at intervals. In this example, therefore, radiation intensity values are collected over a drop detection period, i.e. a period in which print agent is intended to pass through the sampling volume 204 (on the assumption that print agent ejection has occurred, i.e. that the nozzle has not failed completely). As noted above, while the print agent falls though the sampling volume 204, the signal, which is indicative of the radiation intensity, drops to a valley point 103 before increasing to a peak 105 when the drop has already gone through the sampling volume 204. The increase in radiation intensity values above the original level is an artefact of the detector used: when the signal drops, the detector circuitry increases in sensitivity, and therefore increased to a higher level once the shadow of the print agent has passed before levelling out. In FIG. 3, the ‘peak-to-peak’ value is around 155. These measurements are performed for a plurality of nozzles within the printing apparatus, as will be shown with reference to FIGS. 5A and 5B an analysis of the nozzles per printhead may also be performed to determine a printhead health status.

Another interesting feature, that may be monitored from the drop detector signal is the time to valley, i.e., the time elapsed from the time that the nozzle is instructed to eject printing fluid until it reaches the valley 103 which happens when the drop passes through the sampling volume 204. Such a feature is indicative of the drop velocity which is indicative of nozzle health.

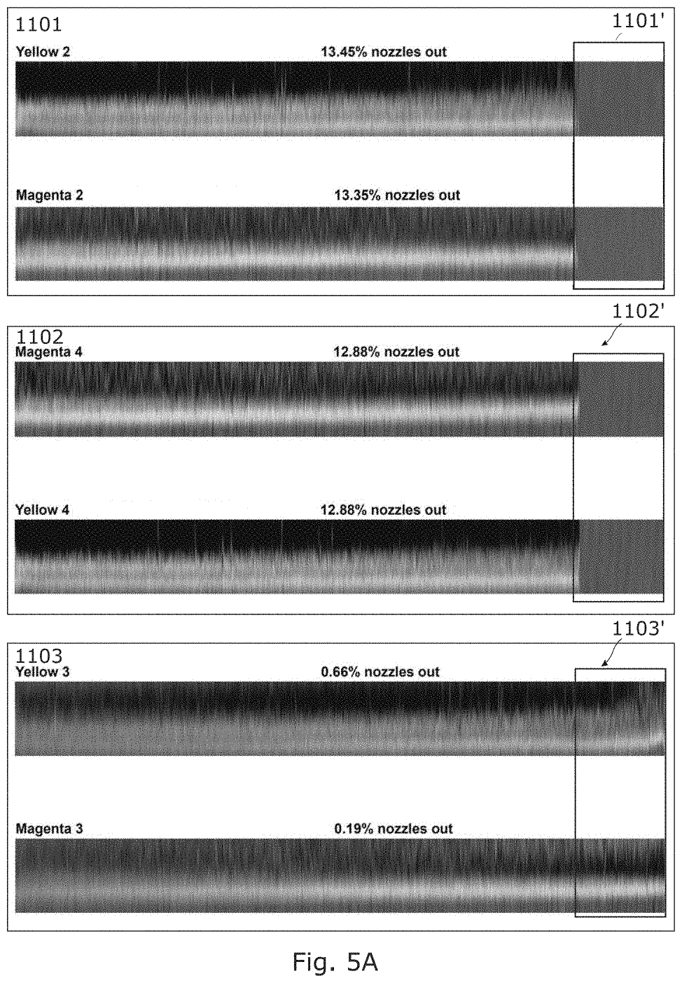

FIG. 4 shows an example of printhead architecture for a print apparatus 100. In the example of FIG. 4 a symmetrical CMYK printhead arrangement is included, i.e., a printhead arrangement 1100 wherein in both direction of travel the printheads are arranged in the same order. The arrangement of FIG. 4 has eight printheads, each having two colors and has four colors: Cyan, Magenta, Yellow, and Black. For ease of explanation, emphasis will be made on the printheads having the Magenta and Yellow colors which will be denominated in the foregoing as a first printhead 1101 for the printhead located in printhead carriage position 2 a second printhead 1102 for the printhead in printhead carriage position 3 and a third printhead 1103 for the printhead in printhead carriage position 3.

The printhead arrangement is to be positioned on a print carriage (not shown) that moves along a scanning direction which corresponds to the length of the printhead arrangement.

During a printing operation, there are conditions that may affect a zone of the printhead arrangement other than individual nozzle, for example, artefacts may enter the print zone and cause nozzle performance issues on several nozzles, for example, a piece of paper may enter the print zone and block the nozzles from firing fluid. In such case, standard maintenance routines such as, e.g., servicing spitting or purging may not be enough to move the piece of paper from the nozzles. In such cases, the drop detector signal of the nozzles may be used to analyse a possible abnormality that may affect a printhead area, such as the edge printing area 111 of FIG. 4. In such a case if, for example, a paper is stuck and blocks the nozzles corresponding to the edge area, it is unlikely that standard servicing operations can remove such an object.

FIGS. 5A and 5B correspond to drop detector measurements performed on a printing arrangement such as the one of FIG. 4. In particular, FIGS. 5A and 5B show nozzle performance for each color wherein the X axis corresponds to a nozzle identification wherein the nozzles at the rightmost end are the nozzles on the lower part of the printhead as shown in FIG. 4 and the leftmost end correspond to nozzles in the upper part of the printhead as shown in FIG. 4. Moreover, the Y axis corresponds to time to valley and the colors correspond to the intensity measured by the drop detector, being the whitest color the less intensity which is indicative of a droplet passing through the detection volume.

FIG. 5A shows the drop detector measurements performed for a plurality of colors, in particular for the Magenta and Yellow colors corresponding to the first printhead 1101, the second printhead 1102 and the third printhead 1103 in a configuration such as the one of FIG. 4. As can be seen from FIG. 5A, there is a similar abnormality 1102′ and 1101′ observed in the drop detector signals or the nozzles corresponding to the edge area 1000 in the printheads of positions 2 and 4, i.e., the first printhead 1101 (the printhead corresponding to colors Yellow 2 and Magenta 2) and the second printhead 1102 (the printhead corresponding to colors Yellow 4 and Magenta 4), whereas the third printhead 1103 (the printhead corresponding to colors Yellow 3 and Magenta 3) has a normal behavior with a signal 1103′ which fails to have such abnormalities. Abnormalities may be determined based, e.g., on the intensity level of the signals as in the current example, i.e., the abnormality refers to having a constant intensity on the drop detector signal which may be indicative that no drop was ejected.

A controller, upon receipt of these signals may correlate the positions of the nozzles showing an abnormal behavior and determine that a cross-nozzle abnormality may be affecting the printheads. In particular, that there may be a nozzle abnormality in the rightmost area of the first printhead 1101 and the second printhead 1102 which the controller may determine that correspond respectively to the nozzles in the edge printing area 111 of the print carriage.

In the context of the present disclosure, The controller may be any combination of hardware and programming to implement the functionalities described herein. These combinations of hardware and programming may be implemented in a number of different ways. In certain implementations, the programming for the controller, and its component parts, may be in the form of processor executable instructions stored on at least one non-transitory machine-readable storage medium and the hardware for the controller may include at least one processing resource to execute those instructions. The processing resource may form part of a printing device within the printing system, or a computing device that is communicatively coupled to the printing device. In some implementations, the hardware may include electronic circuitry to at least partially implement the controller. For example, the controller may comprise an application-specific integrated circuit that forms part of a printing device within the printing system.

In an example, the controller may have access to a memory indicating the relative position of each of the nozzles within a print carriage and may be able to determine distances between nozzles, e.g., may determine that two nozzles separated by a threshold distance may be suffering a similar defect. In a further example, the controller may determine that nozzles within a certain distance from the carriage may be suffering an abnormality. In the example of FIG. 4, the controller may determine that a plurality of nozzles in the first printhead 1101 corresponding to a common area (i.e., in a distance less than a threshold distance, or consecutive nozzles within a region) are having a similar abnormality, therefore, there is indicia of a cross-nozzle abnormality affecting several nozzles in the printhead.

Furthermore, the controller may determine that the second printhead 1102 has nozzles with similar abnormality so the abnormality may also be cross-printhead. In particular, the controller may, knowing the positions of the nozzles within the printhead and/or within the carriage, determine that the nozzles separated from the edge print area 111 by less than a determined threshold distance are showing an abnormal behavior. In other words, the controller may group or associate the cross-nozzle abnormality associated to a first printhead with a cross-nozzle abnormality associated to a second printhead as a cross-printhead abnormality

FIG. 5B shows the drop detector measurements performed in similar conditions of FIG. 5A after the removal of a piece blocking the nozzles corresponding to the rightmost edge of the carriage, in particular, a piece of paper that was found on such a section of the carriage. As can be seen in FIG. 5B, the abnormal behavior is no longer present and the nozzles behave substantially in the same manner throughout each color and between printheads.

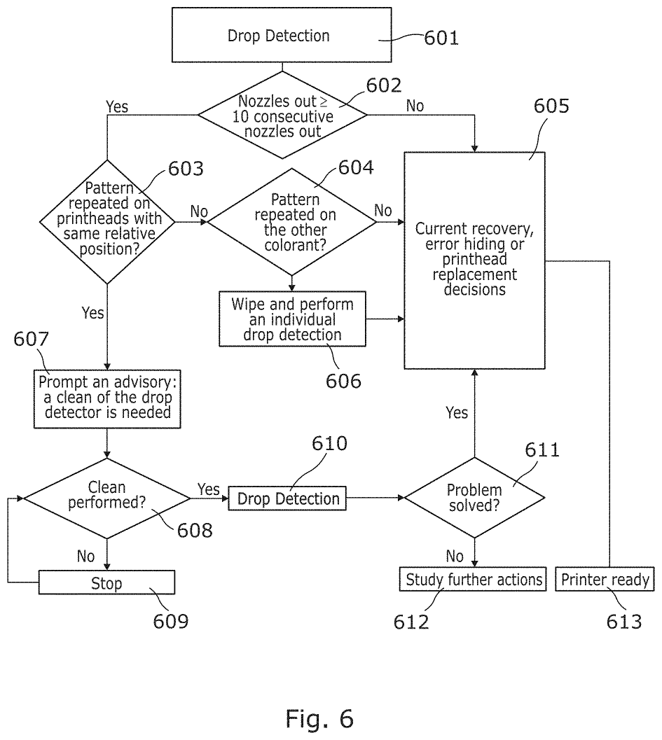

FIG. 6 shows a block diagram illustrating a method to determine possible cross-nozzle abnormalities according to an example. In the method of FIG. 6 a drop detection 601 is performed.

Then the controller may determine if a determined number of consecutive nozzles is showing abnormal behavior, e.g., no drop has been detected. Alternatively, the controller may determine if nozzles within a determined distance for a faulty nozzle exceed a determined threshold. If the number of consecutive nozzles does not exceed the determined number or if in the area there not sufficient nozzles to determine a cross-nozzle defect, then the controller may use a standard servicing operation 605, e.g., error hiding, spitting, purging, nozzle replacement algorithms, etc.

If the number of consecutive nozzles exceed a threshold value, e.g., 10 as shown in FIG. 6, then a check may be performed to determine if the same issue is seen on printheads with the same relative position 603. If the pattern is not repeated on the other colorant 604, then standard servicing operation 605 may be a better fit. Otherwise, a wiping and a new detection may be performed to ensure that a proper measurement was performed.

On the other hand, if the pattern is repeated on other colorants, a cross-printhead and a cross-nozzle effect may be occurring. In such a case, an alert may be sent to the user 607 that a more intensive cleaning operation may be performed. Then, the controller may check for a cleaning operation to be performed 608, if it is not done, a stop of the system is performed 609, otherwise, a drop detection 610 may be performed to determine if the problem has been solved 611. Once the problem is solved a standard maintenance operation 605 may be performed and then the printer may be ready 613 for further printing operations.

The present disclosure has been described in some figures with reference to flow charts and block diagrams of methods, devices and systems according to examples of the present disclosure. Although the flow diagrams described above show a specific order of execution, the order of execution may differ from that which is depicted. Blocks described in relation to one flow chart may be combined with those of another flow chart. It shall be understood that some flows and/or blocks in the flow charts and/or block diagrams, as well as combinations of the flows and/or block in the flow charts and/or block diagrams can be realized by machine readable instructions in combination with processing circuitry.

The machine-readable instructions may, for example, be executed by a general-purpose computer, a special purpose computer, an embedded processor or processors of other programmable data processing devices to realize the functions described in the description and diagrams. In particular, a processor or a processing apparatus may execute the machine-readable instructions. Thus, functional modules of the apparatus (for example, the correlation module 114, and the abnormality detection module 118) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

1. A print apparatus comprising:
a printhead carriage to receive a printhead comprising print agent ejection nozzles;
a drop detector to acquire a signal indicative of variations in a parameter detected by the drop detector over a period of drop detection;
a memory to store nozzle location information of the nozzles; and
processing circuitry comprising a correlation module to correlate the drop detector signal with the nozzle location information
wherein the processing circuitry comprises an abnormality detection module to determine, based on an output of the correlation module, a cross-nozzle abnormality that affects a subset of nozzles.

2. The print apparatus of claim 1, wherein abnormality detection module determines a cross-nozzle abnormality for the subset of nozzles having abnormal drop detection that are separated by less than a threshold signal.

3. The print apparatus of claim 2, wherein an abnormal drop detection is a drop detection with the parameter outside a parameter threshold value.

4. The print apparatus of claim 3, wherein the parameter is one of a drop velocity, drop volume, drop detector signal intensity.

5. The print apparatus of claim 1, wherein the drop detector comprises a radiation detector to detect radiation intensity.

6. The print apparatus of claim 1, wherein the print apparatus comprises a plurality of printheads and wherein the abnormality detection module may group a first cross-nozzle abnormality associated to a first printhead with a second cross-nozzle abnormality associated to a second printhead as a cross-printhead abnormality.

7. The print apparatus of claim 6 wherein the abnormality detection module determines a cross-printhead abnormality when the first cross-nozzle abnormality is determined at a similar distance with the second cross-nozzle abnormality along a dimension of the print carriage.

8. The print apparatus of claim 1, wherein based on an output from the abnormality detection module an indication of blocking artefact is issued.

9. A method comprising a processor to:
acquire a signal from a detector to detect a passage of print agent ejected from a printhead nozzle;
determine, using a processor an operational parameter of the printhead nozzle;
determine a set of locations of a subset of nozzles having abnormal operational parameters; and
determine a cross-nozzle abnormality for the subset of nozzles whose locations are within a similar distance from a reference within printhead carriage.

10. The method of claim 9 wherein reference is an edge of the printhead carriage.

11. The method of claim 9, wherein the detector comprises a radiation detector to detect radiation intensity

12. The method of claim 11, wherein the parameter is one of a drop velocity, drop volume, a signal intensity.

13. Tangible machine-readable medium comprising instructions which, when executed by a processor, cause the processor to:
acquire a signal from a detector to detect a passage of print agent ejected from a printhead nozzle;
determine, using a processor an operational parameter of the printhead nozzle;
determine a set of locations of a subset of nozzles having abnormal operational parameters;
determine a cross-nozzle abnormality for the subset of nozzles whose locations are within a similar distance from a reference within printhead carriage.

14. Tangible machine readable medium according to claim 13, wherein reference is an edge of the printhead carriage.

15. Tangible machine readable medium according to claim 13 wherein the detector comprises a radiation detector to detect radiation intensity.
